(19) United States
(12) Patent Application Publication
(10) Pub. No.: US 2013/0058000 A1
(43) Pub. Date: Mar. 7, 2013

(54) System and method for deterring birds and small animals

(71) Applicants: Thomas Kaps, Jackson, NJ (US); Paul Rosario, Bayville, NJ (US)

(72) Inventors: Thomas Kaps, Jackson, NJ (US); Paul Rosario, Bayville, NJ (US)

(21) Appl. No.: 13/199,621

(22) Filed: Sep. 6, 2011

(51) Int. Cl. H01T 23/00

(52) U.S. Cl. 361/232

(57) ABSTRACT

A system for deterring birds, small animals or the like. The system comprises: a plurality of two-conductor or paired conductor modules or units with some modules being fully insulated and with other modules being partially un-insulated; wherein the birds, small animals or the like complete an electrical circuit with parts of their body between the two-conductor pairs of the partially un-insulated module portions thereby providing an electrical shock to the bird, small animal or the like.

### BACKGROUND OF THE INVENTION

1. Field of the Invention

This invention relates to a system and method for deterring birds and small animals and in particular to such a system and method utilizing insulated and un-insulated electrically conductive modules or units.

2. Description of the Prior Art

The prior art reveals the following patent references:
1. Bayes U.S. Pat. No. 4,299,048, issued on Nov. 10, 1981 and entitled “Pest Bird Control”, which discloses:
   “An electrical device for mass exterminating of objectable pest birds, such as starlings or the like; the device including an overhead cable supported between posts, the cable carrying a plurality of spaced-apart copper electrodes along its outer side, so that, when a horde of pest birds try to land upon the wire by their toes straddling it, they close an electric circuit between the electrodes, which are connected to a power source, so that the birds are thus electrocuted.”
   “An improved pest bird control device, comprising, in combination, an overhead cable, spaced-apart positive and negative electrodes along said cable connected to a switch and a power source, and automatic warning means when a large number of pest birds have alighted upon said cable.”
2. Dressel U.S. Pat. No. 4,862,637, issued on Sep. 5, 1989 and entitled “Bird Repelling System With Improved Mounting Fixture”, which discloses:
   “A vineyard has conductive trellis wires which extend between poles to provide support for the grape vines. At least some of the trellis wires are grounded. A number of identical bird repelling devices are widely spaced throughout the vineyard. Each has a length much shorter than the distance between adjacent vineyard poles, the length being sufficient to allow a bird to land. The bird repelling devices have a circumference less than approximately one and one-half inch to allow the feet of a bird landing thereon to cover most of its circumference. Each bird repelling device is composed of an elongate insulating member and an electrically conductive rod secured to it. The rod is substantially as long as the elongate insulating member. A high voltage is applied to each electrically conductive rod. Each of the elongate insulating members is secured to a portion of the trellis wires parallel to the trellis wires. A bird landing on a bird repelling device completes a circuit between the trellis wire and the electrically conductive rod carried by that bird repelling device. This shocks the bird without substantially harming it so that the bird flies away. Mounting fixtures mounted on vineyard poles at the ends of rows readily accept, hold, and automatically make electrical contact with modified bird repelling devices.”
   “A system for repelling birds from a vineyard or the like, said vineyard having trellis wires stretched generally horizontally between a plurality of poles for the grape vines to grow along, said bird repelling system comprising: means for grounding at least some of the trellis wires; a plurality of elongate insulating members, each having a length much shorter than the distance between adjacent vineyard poles, the length being sufficient to allow a bird to land thereon, the elongate insulating member having a circumference less than approximately one and one-half inches to allow the feet of a bird landing thereon to cover most of the circumference of the elongate insulating member; for each elongate insulating member, an electrically conductive rod secured to its corresponding elongate insulating member along the length thereof, said rod being substantially as long as the elongate insulating member; means for applying a high voltage to each electrically conductive rod; each of said plurality of elongate insulating members being adapted to be secured to selected portions of the trellis wires parallel to said trellis wires so that a bird landing on an elongate insulating member completes a circuit between the trellis wire and the electrically conductive rod carried by that elongate insulating member to shock the bird without substantially harming it so that the bird flies away.”
   “A system for repelling birds from a vineyard or the like, said vineyard having trellis wires stretched generally horizontally between a plurality of poles for the grape vines to grow along, said bird repelling system comprising: means for grounding at least some of the trellis wires; a first set of elongate insulating members, each having a length much shorter than the distance between adjacent vineyard poles, the length being sufficient to allow a bird to land thereon, the elongate insulating member having a circumference less than approximately one and one-half inches to allow the feet of a bird landing thereon to cover most of the circumference of the elongate insulating member; for each elongate insulating member of the first set, an electrically conductive rod secured to its corresponding elongate insulating member along the length thereof, said rod being substantially as long as the elongate insulating member; means for applying a high voltage to each electrically conductive rod; each of said elongate insulating members of the first set being adapted to be secured to selected portions of the trellis wires parallel to said trellis wires so that a bird landing on an elongate insulating member completes a circuit between the trellis wire and the electrically conductive rod carried by that elongate insulating member to shock the bird without substantially harming it so that the bird flies away; a second set of elongate insulating members, each member of the second set fixedly carrying a pair of electrically conductive rods on opposite sides thereof; and a plurality of mounting fixtures fixedly secured to predetermined vineyard poles, each fixture having means for removably holding an elongate member of the second set in place and for automatically making electrical connection with both conductive rods carried by said member.”
   “In a system for repelling birds from a vineyard, said vineyard having a plurality of poles for supporting grape vines at least indirectly, a plurality of bird repelling devices for mounting to selected vineyard poles, said bird repelling devices each including an elongate insulating member fixedly carrying a pair of electrically conductive rods on opposite sides thereof, the conductive rods being substantially the same length as the elongate insulating member, and a plurality of mounting fixtures for removably mounting the bird repelling devices to the vineyard poles, each mounting fixture including means for removably holding a bird repelling device in place and for automatically making separate electrical connections with both conductive rods carried thereby upon rotational insertion of the bird repelling device, and means for fixedly securing the mounting fixture to a vineyard pole.”
3. Nickerson patent application publication 2004-0098898, published on May 27, 2004 and entitled “Bird Deterrent System For Crop Protection”, which discloses:
   “There is provided a system for deterring small animals away from a selected area. The system comprises a central support member having an axis of rotation. Moreover, at least one elongated member is attached to the central support member and extends radially with respect to the axis of rotation. Further, a motor is in mechanical communication with the central support member. The motor is operative to rotate the central support member about the axis of rotation for moving the elongated member(s) about the axis of rotation. Lastly, a controller is in electrical communication with the motor. The controller is configured to activate the motor to rotate the central support member intermittently about the axis of rotation. This moves the elongated member(s) to deter the small animals away from the selected area.”
   “A system for deterring small animals away from a selected area, the system comprising: a central support member having an axis of rotation; at least one elongated member attached to the central support member and extending radially with respect to the axis of rotation; a motor in mechanical communication with the central support member and being operative to rotate the central support member about the axis of rotation for moving the elongated member(s) about the axis of rotation; and a controller in electrical communication with the motor, the controller being configured to activate the motor to rotate the central support member intermittently about the axis of rotation for moving the elongated member(s) to deter the small animals away from the selected area.”
4. Ravenelle et al U.S. Pat. No. 7,249,436, issued on Jul. 31, 2007 and entitled “Electric Shock Bird And Animal Deterrent”, which discloses:
   “An animal and bird deterrent apparatus is disclosed. The apparatus includes a flexible dielectric material, and electrically conducting strips disposed on a top surface of the flexible material. In one embodiment the flexible material is secured to a structure by an adhesive and the strips are coupled to a high voltage source such that a shock is provided.”
   “A tape for deterring birds and animals, comprising: a flexible elongate substantially planar base material having a top surface and a bottom surface; an intermediary layer securely disposed on said top surface of said base material; at least two solid metal conducting strips securely disposed on said intermediary layer by an adhesive, wherein said strips are separated by a gap to avoid arcing between said strips, and wherein each of said conducting strips has a side margin to avoid arcing between said conducting strips and a structure upon which said tape is installed; a film material disposed on said intermediary layer about said conducting strips such that said conducting strips are not covered by said film material; wherein said base material in combination with said intermediary layer, has a dielectric property sufficient to insulate said conducting strips from a structure upon which said tape is installed; and wherein said tape is a thin composite laminate.
   “A system for deterring birds and animals, comprising: a substantially planar flexible pad of a dielectric material; a pair of solid metal conductive strips disposed in a pattern upon a surface of said pad by an adhesive, wherein said pair of strips overlap each other but are electrically isolated from each other by high dielectric sections situated approximately between said overlapping pair of strips; and a high voltage source operatively coupled to said conductive strips.”
   “A thin composite laminate tape for deterring birds and animals, comprising: a flexible elongate substantially planar base material having a top surface and a bottom surface; a first adhesive layer disposed on at least a portion of the top surface of the base material; an intermediary layer securely disposed on said first adhesive layer; at least two sections of adhesive disposed upon said intermediary layer; at least two solid metal conducting strips securely disposed on said two sections, wherein said strips are separated by a gap to avoid arcing between said strips; and wherein said base material in combination with said first adhesive, said intermediary layer, said two sections of adhesive and said conducting strips form said composite laminate tape.”
5. Donoho U.S. Pat. No. 7,802,396, issued on Sep. 28, 2010 and entitled “Electrified Bird Repellent Track”, which discloses:
   “An animal deterring device has a carrier with first and second conductive traces that are separated by an arc suppressor. Most typically, the arc suppressor is configured to eliminate short circuiting of the device when exposed to fog, dew, rain, or animal excrements while at the same time to allow an animal to contact both conductive traces at the same time.”
   “An animal deterring device comprising a carrier having a first conductive trace that is separated from a second conductive trace by an arc suppressor that has at least one of (a) an umbrelloid shape, and (b) a configuration effective to increase creep distance between the first and second conductive traces by at least 1.5 times.”
   “An animal deterring device comprising a stripe-shaped carrier having a first conductive trace that is separated from a second conductive trace by an umbrelloid arc suppressor, and wherein the device has a height to width ratio between 1:5 and 1:2.”
6. Donoho patent application publication 2011-0067646, published on Mar. 24, 2011 and entitled “Electrified Bird Repellent Track”, which discloses:
   “An animal deterring device has a carrier with first and second conductive traces that are separated by an arc suppressor. Most typically, the arc suppressor is configured to eliminate short circuiting of the device when exposed to fog, dew, rain, or animal excrements while at the same time to allow an animal to contact both conductive traces at the same time.”
   “An animal deterring device comprising: an elongated carrier having a first conductive trace that is separated from a second conductive trace; and wherein the carrier has a bottom with a first glue trough.”
7. Donoho U.S. Pat. No. 7,937,885, issued on May 10, 2011 and entitled “Electrified Bird Repellent Track”, which discloses:
   An animal deterring device has a carrier with first and second conductive traces that are separated by an arc suppressor. Most typically, the arc suppressor is configured to eliminate short circuiting of the device when exposed to fog, dew, rain, or animal excrements while at the same time to allow an animal to contact both conductive traces at the same time.
   An animal deterring device comprising: a stripe-shaped carrier having a first conductive trace that is separated from a second conductive trace by an umbrelloid arc suppressor; wherein the carrier has a cutout that is configured to allow bending of the device; and wherein the device has a height to width ratio between 1:5 and 1:2.

A review of the above cited patent references reveals that such references do not disclose applicants' claimed invention.

### 3. SUMMARY OF THE PRESENT INVENTION

According to one embodiment of the present invention, A system for deterring birds, small animals or the like comprises: a plurality of two-conductor or paired conductor modules or units with some modules being fully insulated and with other modules being partially un-insulated; wherein such birds, small animals or the like may complete an electrical circuit with parts of their body between the two-conductor pairs of the un-insulated module portions thereby providing an electrical shock to the bird, small animal or the like.

Features of the present invention are that:

The system may utilize a tree trunk and at least one tree branch for supporting and operating the system structure.
The system comprises first and second selectively insulated electrically conductive means, wires or the like.
The system comprises first and second selectively un-insulated electrically conductive means, wires or the like.

Objects of the present invention are to:

1. Deter birds, small animals or the like from gathering on a tree.
2. Deter the leader bird of a flock of birds thereby causing the rest of the flock to be deterred from that tree and nearby trees.
3. Utilize the tree trunk and at least one tree branch to support the system.

### BRIEF DESCRIPTION OF THE DRAWINGS

The above and other objects, advantages and features of the present invention will be further appreciated from a reading of the following detailed description in conjunction with the drawing in which:

FIG. 1A, FIG. 1B, and FIG. 1C show various embodiments of insulated two-conductor or paired conductor modules or units according to the present invention.

FIG. 2A, FIG. 2B, and FIG. 2C also show various embodiments of such insulated conductive modules or units according to the present invention.

FIG. 3A, FIG. 3B, and FIG. 3C show various embodiments of partially insulated and partially un-insulated conductive modules or units according to the present invention.

FIG. 4A, FIG. 4B, and FIG. 4C also show various embodiments of such partially insulated and partially un-insulated conductive modules or units according to the present invention.

FIG. 5A shows an embodiment of associated linear insulated conductive modules or units and their associated control module according to the present invention; FIG. 5B shows an embodiment of system 10 according to the present invention; FIG. 5C shows a tree branch with an embodiment of associated partially insulated and partially un-insulated conductive modules or units according to the present invention.

FIG. 6A shows an embodiment of a base support element according to the present invention; FIG. 6B shows another view of such embodiment of a base support element according to the present invention.

FIG. 7A shows an embodiment of a multi-terminal current distribution element according to the present invention; FIG. 7B shows such embodiment of a multi-terminal current distribution element with associated tree trunk attachment elements according to the present invention; FIG. 7C shows an embodiment of a velcro attachment element according to the present invention.

FIG. 8A shows an embodiment of a solar-powered battery charger according to the present invention; and FIGS. 8B, 8C, 8D and 8E shows various applied voltage/current waveforms according to the present invention.

FIG. 9 shows an embodiment of an artificial tree branch system according to the present invention.

### DETAILED DESCRIPTION OF THE INVENTION

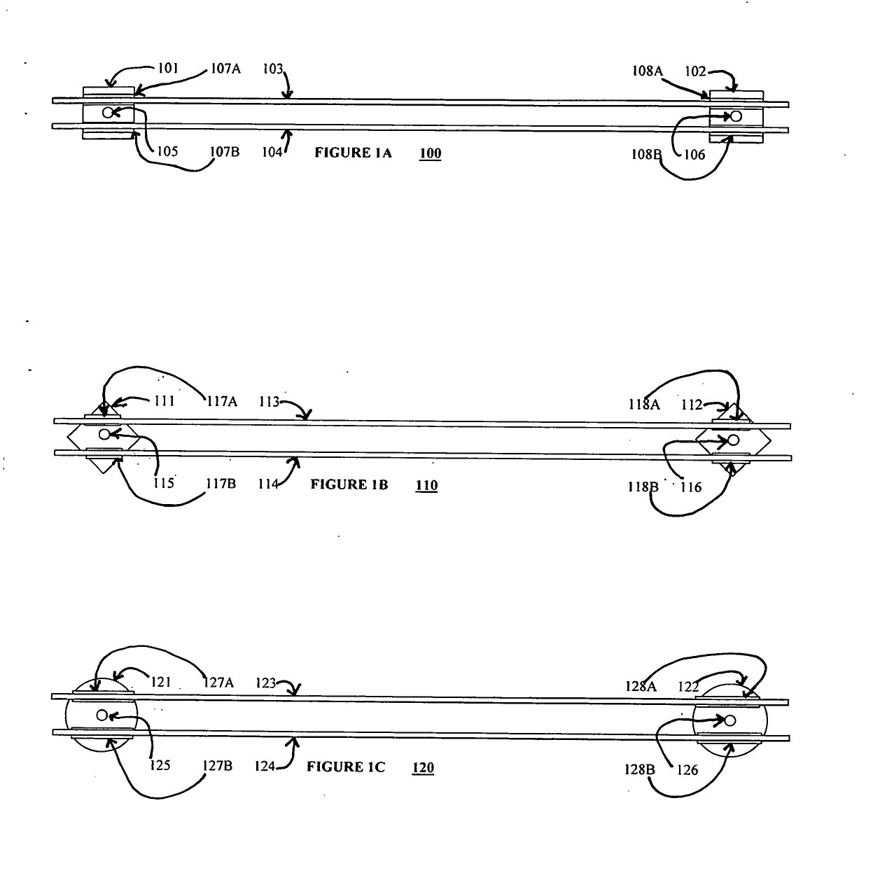

### FIG. 1A, FIG. 1B, FIG. 1C

FIG. 1A, FIG. 1B, and FIG. 1C show various embodiments of insulated two-conductor or paired conductor modules or units according to the present invention.

FIG. 1A shows insulated two-conductor or paired conductor module or unit 100 comprising: first base support unit 101 with through hole 105 and grooves or cutouts 107A and 107B; second base support unit 102 with through hole 106 and grooves or cutouts 108A and 108B; first insulated conductive means 103; and second insulated conductive means 104. Base support units 101 and 102 have square cross-sections whose front and rear vertical walls are parallel to the direction of conductive means 103 and 104. Conductive means 103 and 104 are fully insulated in this embodiment. Holes 105 and 106 are respectively utilized to secure base support units 101 and 102 onto the underlying substrate or tree trunk or branch with a through nail, screw or similar means. Grooves 107A and 108A accommodate conductive means 103. Grooves 107B and 108B accommodate conductive means 104.

FIG. 1B shows insulated conductive module or unit 110 comprising: first base support unit 111 with through hole 115 and grooves or cutouts 117A and 117B; second base support unit 112 with through hole 116 and grooves or cutouts 118A and 118B; first insulated conductive means 113; and second insulated conductive means 114. Base support units 111 and 112 have square cross-sections whose vertical walls are diagonal to or at 45 degrees to the direction of conductive means 113 and 114. Conductive means 113 and 114 are fully insulated in this embodiment. Holes 115 and 116 are respectively utilized to secure base support units 111 and 112 onto the underlying substrate or tree trunk or branch with a through nail, screw or similar means. Grooves 117A and 118A accommodate conductive means 113. Grooves 117B and 118B accommodate conductive means 114.

FIG. 1C shows insulated conductive module or unit 120 comprising: first base support unit 121 with through hole 125 and grooves or cutouts 127A and 127B; second base support unit 122 with through hole 126 and grooves or cutouts 128A and 128B; first insulated conductive means 123; and second insulated conductive means 124. Base support units 121 and 122 have circular cross-sections whose vertical walls are perpendicular to the direction of conductive means 123 and 124. Conductive means 123 and 124 are fully insulated in this embodiment. Holes 125 and 126 are respectively utilized to secure base support units 121 and 122 onto the underlying substrate or tree trunk or branch with a through nail, screw or similar means. Grooves 127A and 128A accommodate conductive means 123. Grooves 127B and 128B accommodate conductive means 124.

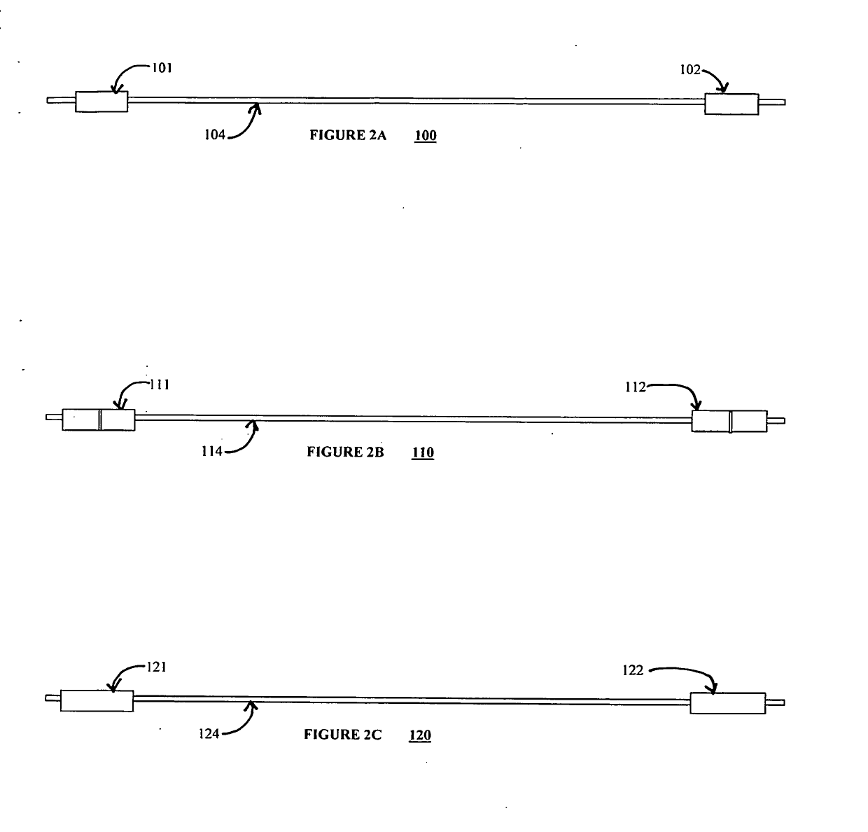

### FIG. 2A, FIG. 2B, FIG. 2C

FIG. 2A, FIG. 2B, and FIG. 2C also show various embodiments of such insulated two-conductor or paired conductor modules or units according to the present invention.

FIG. 2A shows insulated two-conductor or paired conductor module or unit 100 comprising: first base support unit 101; second base support unit 102; and second insulated conductive means 104.

FIG. 2B shows insulated two-conductor or paired conductor module or unit 110 comprising: first base support unit 111; second base support unit 112; and second insulated conductive means 114.

FIG. 2C shows insulated two-conductor or paired conductor module or unit 120 comprising: first base support unit 121; second base support unit 122; and second insulated conductive means 124.

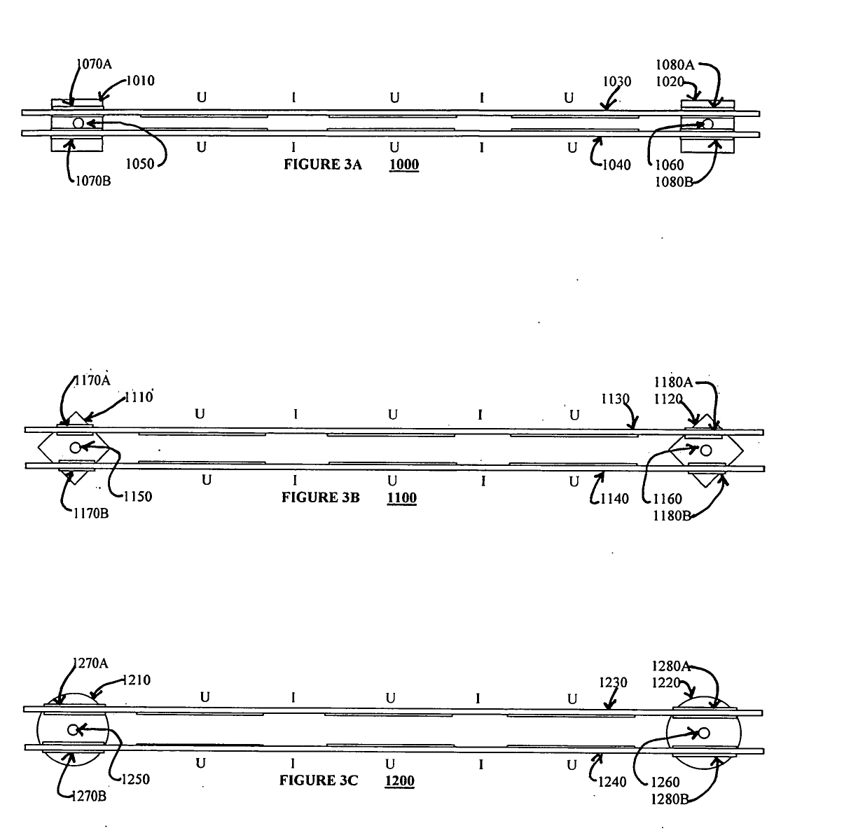

### FIG. 3A, FIG. 3B, FIG. 3C

FIG. 3A, FIG. 3B, and FIG. 3C show various embodiments of partially insulated and partially un-insulated two-conductor or paired conductor modules or units according to the present invention.

FIG. 3A shows partially insulated and partially un-insulated conductive module or unit 1000 comprising: first base support unit 1010 with through hole 1050 and grooves or cutouts 1070A and 1070B; second base support unit 1020 with through hole 1060 and grooves or cutouts 1080A and 1080B; first partially insulated and partially un-insulated conductive means 1030; and second partially insulated and partially un-insulated conductive means 1040. Base support units 1010 and 1020 have square cross-sections whose front and rear vertical walls are parallel to the direction of conductive means 1030 and 1040. Conductive means 1030 and 1040 are insulated at sections I and un-insulated at sections U in this embodiment. Holes 1050 and 1060 are respectively utilized to secure base support units 1010 and 1020 to the underlying substrate or tree trunk or tree branch with a through nail, screw or similar means. Grooves 1070A and 1080A accommodate conductive means 1030. Grooves 1070B and 1080B accommodate conductive means 1040.

FIG. 3B shows partially insulated and partially un-insulated conductive module or unit 1100 comprising: first base support unit 1110 with through hole 1150 and grooves or cutouts 1170A and 1170B; second base support unit 1120 with through hole 1160 and grooves or cutouts 1180A and 1180B; first partially insulated and partially un-insulated conductive means 1130; and second partially insulated and partially un-insulated conductive means 1140. Base support units 1110 and 1120 have square cross-sections whose front and rear vertical walls are diagonal to or at 45 degrees to the direction of conductive means 1130 and 1140. Conductive means 1130 and 1140 are insulated at sections I and un-insulated at sections U in this embodiment. Holes 1150 and 1160 are respectively utilized to secure base support units 1110 and 1120 to the underlying substrate or tree trunk or tree branch with a through nail, screw or similar means. Grooves 1170A and 1180A accommodate conductive means 1130. Grooves 1170B and 1180B accommodate conductive means 1140.

FIG. 3C shows partially insulated and partially un-insulated conductive module or unit 1200 comprising: first base support unit 1210 with through hole 1250 and grooves or cutouts 1270A and 1270B; second base support unit 1220 with through hole 1260 and grooves or cutouts 1280A and 1280B; first partially insulated and partially un-insulated conductive means 1230; and second partially insulated and partially un-insulated conductive means 1240. Base support units 1210 and 1220 have circular cross-sections whose vertical walls are perpendicular to the direction of conductive means 1230 and 1240. Conductive means 1230 and 1240 are insulated at sections I and un-insulated at sections U in this embodiment. Holes 1250 and 1260 are respectively utilized to secure base support units 1210 and 1220 to the underlying substrate or tree trunk or tree branch with a through nail, screw or similar means. Grooves 1270A and 1280A accommodate conductive means 1230. Grooves 1270B and 1280B accommodate conductive means 1240.

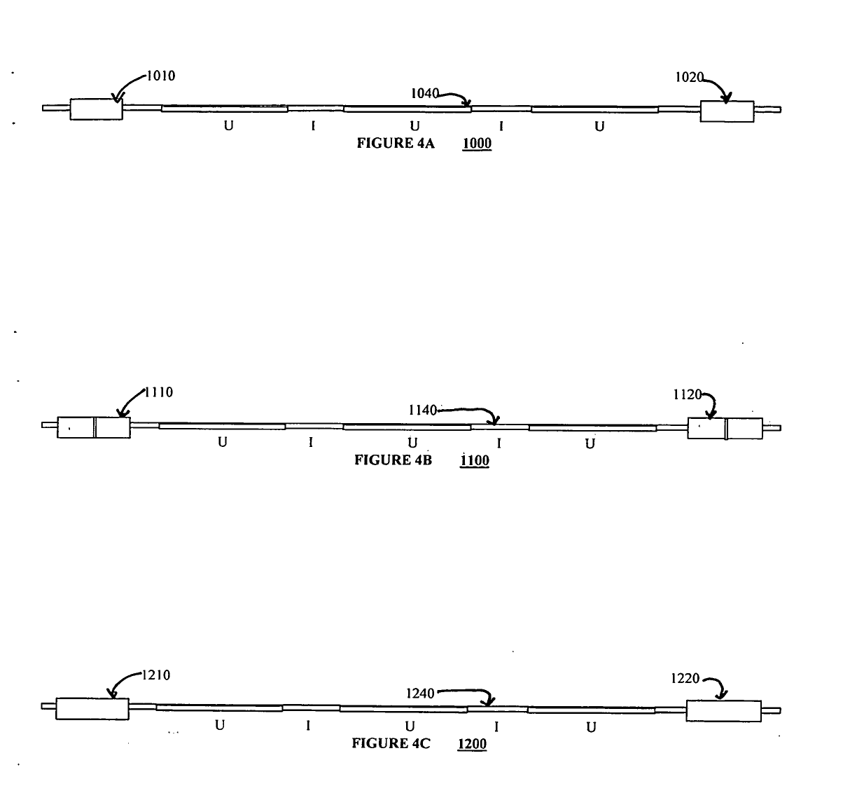

### FIG. 4A, FIG. 4B, FIG. 4C

FIG. 4A, FIG. 4B, and FIG. 4C also show various embodiments of such partially insulated and partially un-insulated conductive modules or units according to the present invention.

FIG. 4A shows partially insulated and partially un-insulated conductive module or unit 1000 comprising: first base support unit 1010; second base support unit 1020; and second partially insulated and partially un-insulated conductive means 1040. Conductive means 1040 is insulated at sections I and un-insulated at sections U in this embodiment.

FIG. 4B shows partially insulated and partially un-insulated conductive module or unit 1100 comprising: first base support unit 1110; second base support unit 1120; and second partially insulated and partially un-insulated conductive means 1140. Conductive means 1140 is insulated at sections I and un-insulated at sections U in this embodiment.

FIG. 4C shows partially insulated and partially un-insulated conductive module or unit 1200 comprising: first base support unit 1210; second base support unit 1220; and second partially insulated and partially un-insulated conductive means 1240. Conductive means 1240 is insulated at sections I and un-insulated at sections U in this embodiment.

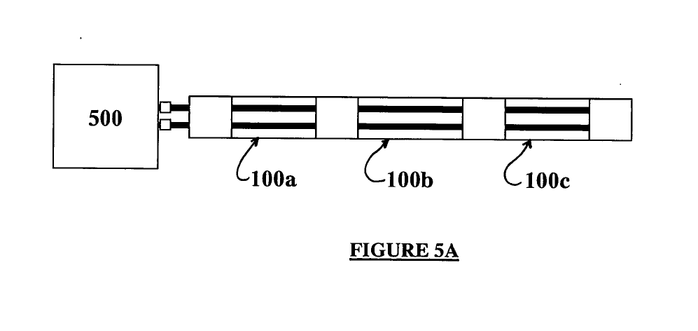

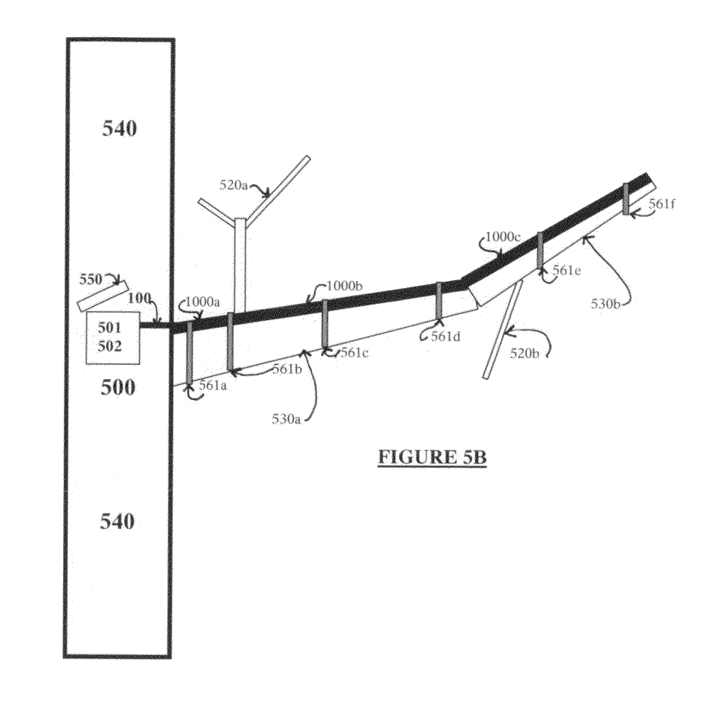

### FIG. 5A, FIG. 5B

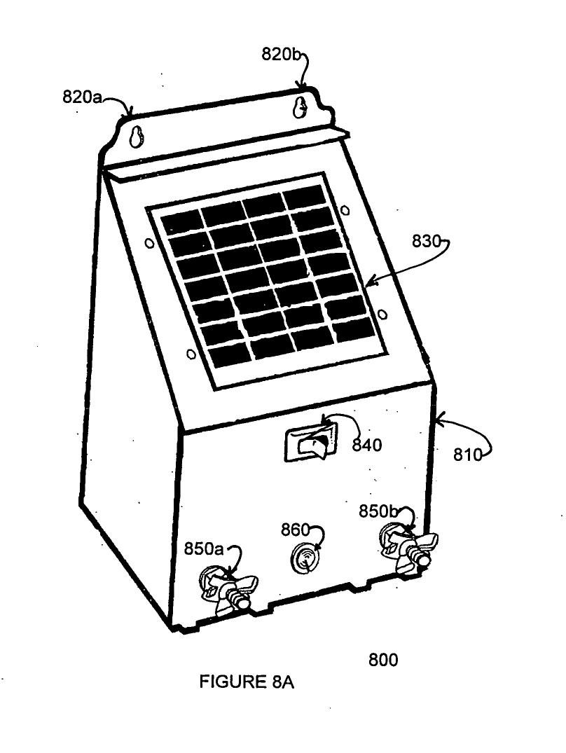

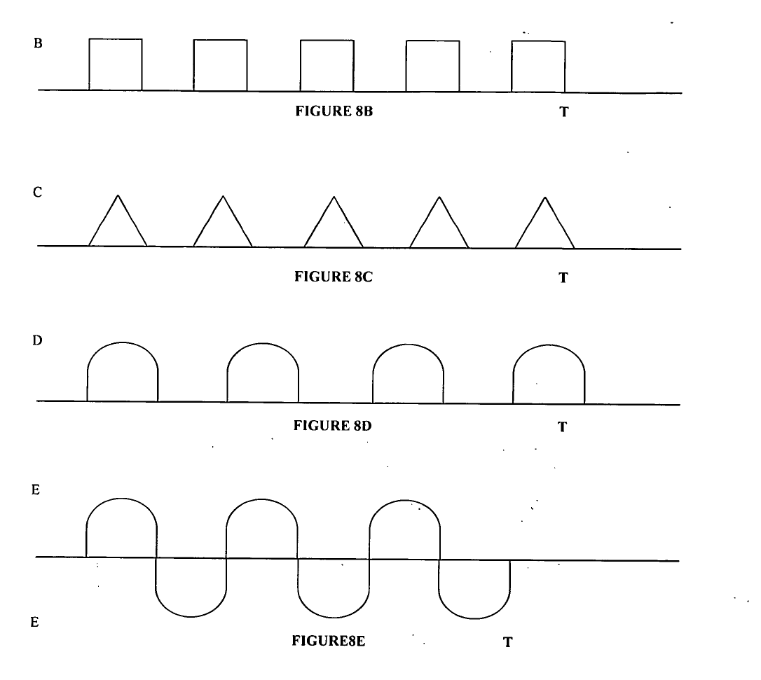

FIG. 5A shows an embodiment of associated linear insulated conductive modules or units and their associated control module according to the present invention. FIG. 5A shows control unit 500 and a plurality of insulated conductive modules or units 100a, 100b, and 100c in series being powered by control unit 500. Control unit 500 may include means for controlling the current amplitude, voltage amplitude, current waveform and voltage waveform being applied to insulated conductive modules 100a, 100b, and 100c. Such current and voltage waveforms may be present all the time or may be controlled as a function of time by control unit 500. See FIGS. 8B, 8C, 8D and 8E.

FIG. 5B shows an embodiment of system 10 according to the present invention. FIG. 5B shows: tree trunk 540; control unit 500; solar array 550; tree branch sections 530a and 530b; projecting smaller tree branch sections 520a and 520b; insulated conductive modules or units 100; partially un-insulated conductive modules or units 1000a, 1000b and 1000c; and elastic ties 561a-561f. Solar array 550 receives sunlight and provides a voltage-current waveform to rechargeable battery 501 located within control unit 500. Rechargeable battery 501 in turn provides a voltage-current waveform to control circuit 502 located within control unit 500 for providing the desired waveform to be applied to insulated conductive modules 100. Finally partially un-insulated conductive modules 1000a, 1000b and 1000c receive such waveform from insulated conductive modules 100. Elastic ties 561a-561f secure insulated conductive modules 100 and partially un-insulated conductive modules 1000a, 1000b and 1000c to tree branches 530a and 530b. Partially un-insulated conductive modules 1000a, 1000b and 1000c each comprise two conductive means as in FIG. 3A, 3B or 3C. Should a bird or small animal walk along or land upon tree branches 530a and 530b and should any part of their body make complete electrical contact with such pairs of conductive means to complete an electrical circuit then such bird or small animal will receive an electrical shock causing it to leave the tree.

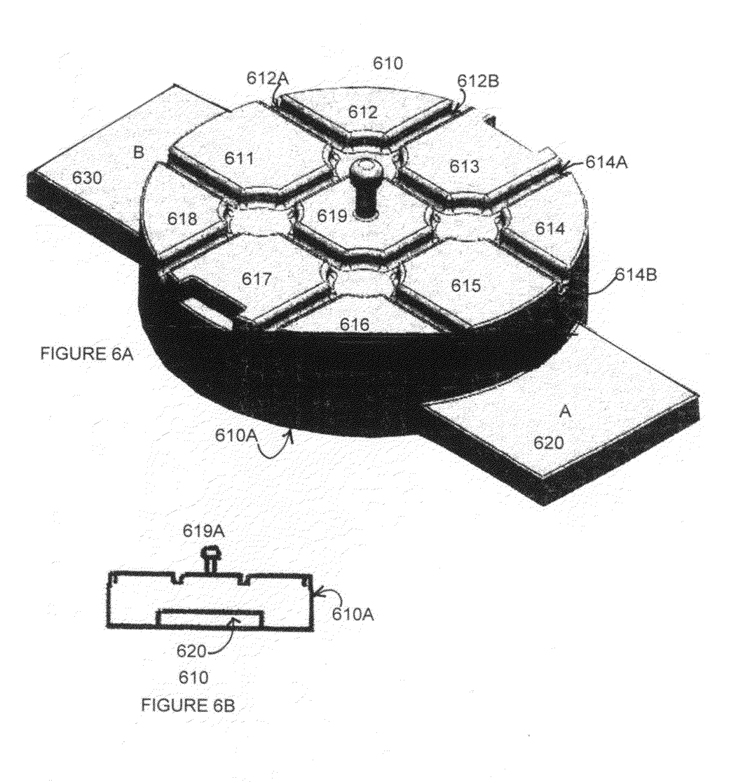

### FIG. 6A, FIG. 6B

FIG. 6A shows an embodiment of a base support element or unit according to the present invention. Base support element 610 comprises: cylindrical section 610A; first extension 620; and second extension 630. Cylindrical section 610A further comprises: outer upper surfaces 611, 612, 613, 614, 615, 616, 617, 618; and inner upper surface 619. Adjacent upper surfaces are separated from each other to define or form grooves or cutouts. For example, upper surface 612 has associated therewith grooves 612A and 612B; upper surface 613 has associated therewith grooves 612B and 614A; and upper surface 614 has associated therewith grooves 614A and 614B. A similar explanation applies to the rest of such upper surfaces and their associated grooves. Central upper surface 619 includes a through central hole for accommodating a through nail, screw or other similar means for securing base support element 610 to its underlying substrate or tree trunk or tree branch. The longitudinal direction of base support element 610 is directed along the direction of extensions 620 and 630. Accordingly, first and second conductive means may placed and securely embedded or snapped in place along the longitudinally directed grooves associated with peripheral upper surface 615, central upper surface 619 and peripheral upper surface 611. On the other hand, the first of a pair of conductive means may placed and securely embedded along longitudinally directed groove 614B associated and then directed in a perpendicular direction along groove 614A. Similarly, the second of such pair of conductive means may placed and securely embedded along the longitudinally directed groove associated with upper surfaces 615 and 616; then along the longitudinally directed groove associated with upper surfaces 619 and 617; then directed in a perpendicular direction along the grooves associated with upper surfaces 619 and 611; and then along groove 612B. Base support element 610 may include rectangular shaped or other shaped through holes at location A at first extension 620 or at located B at second extension 630 for facilitating snapping onto the substrate or tree trunk or tree branch.

FIG. 6B shows another view of base support element 610 according to the present invention. FIG. 6B shows base support element 610 comprising first extension 620; cylindrical surface 610A; and securing means such as nail or screw 619A or similar means.

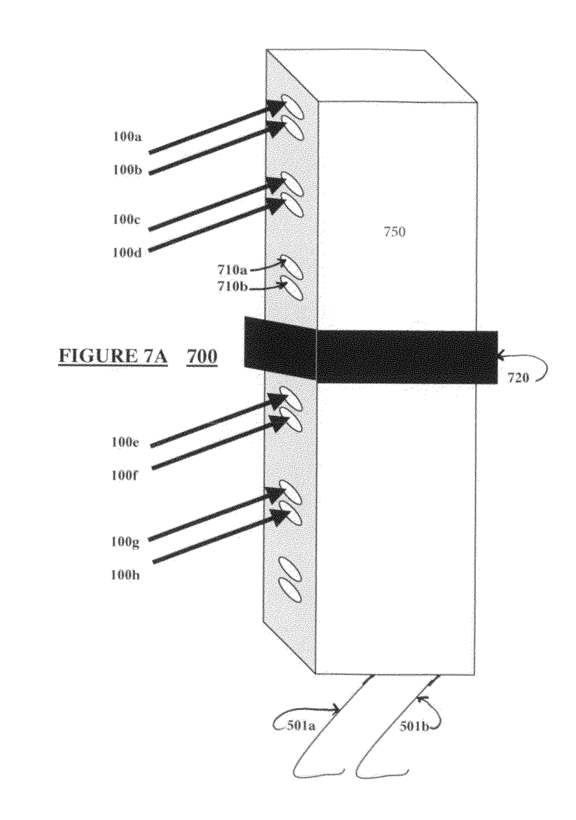

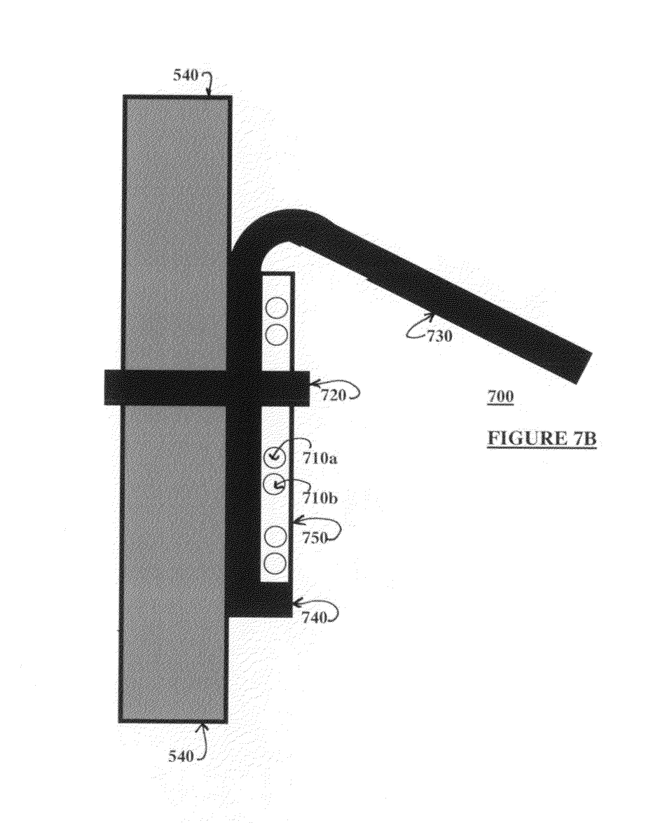

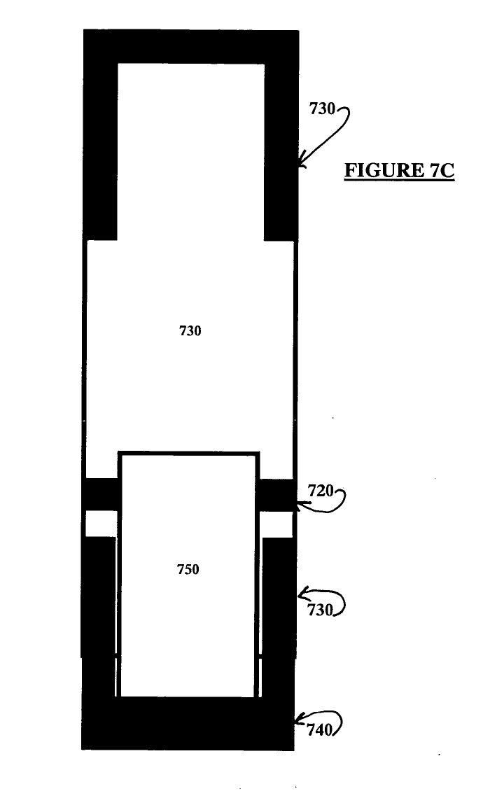

### FIG. 7A, FIG. 7B, FIG. 7C

FIG. 7A is a perspective view of a current distribution terminal 700 according to the present invention. FIG. 7A shows: terminal body 750; input current/voltage source connectors or wires 501a and 501b; output current/voltage terminals 710a and 710b; velcro holding or attachment strap 720; and attached output insulated conductive pairs 100a/100b, 100c/100d, 100e/100f, 100g/100h. Conductive pairs 100 are connected to terminals 710.

FIG. 7B is a side or lateral view of current distribution element 700 according to the present invention. FIG. 7B shows: terminal body 750; tree attachment strap 720; terminal attachment strap 740; lateral output terminals 710a/710b; and partially folded velcro attachment member 730. Current distribution element 700 is thus securely attached to tree trunk 540.

FIG. 7C is a front view of velcro attachment element 730 in the un-folded configuration according to the present invention. FIG. 7C shows tree attachment strap 720 and terminal body attachment strap 740.

### FIG. 8A, FIG. 8B, FIG. 8C, FIG. 8D, FIG. 8E

FIG. 8A is a perspective view of solar-powered battery charger 800; and FIGS. 8B through 8E are various applied waveforms according to the present invention. FIG. 8A shows: housing 810; mounting brackets 820a/820b; solar cells 830; on/off control switch 840; output current/voltage terminals 850a/850b; and on/off indicator light 860. Charger 800 comprises an internal re-chargeable battery which would then provide a current/voltage output at terminals 850a/850b. Control unit 500 of FIGS. 5A and 5B would then modify the output of charger 800 to be: a square pulse voltage/current waveform; a triangular pulse voltage/current waveform; a half sinusoidal voltage/current waveform; a full sinusoidal voltage/current waveform; a constant voltage/current waveform; or any other chosen voltage/current waveform. See FIGS. 8A through 8E.

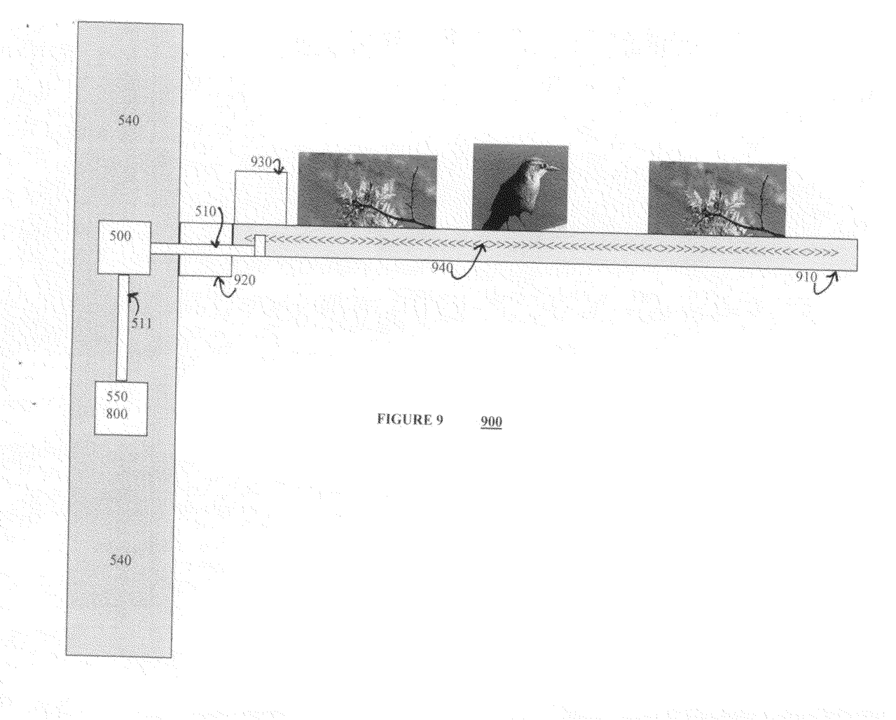

### FIG. 9

FIG. 9 is a side or lateral view of artificial tree branch system 900 according to the present invention. FIG. 9 shows: artificial or simulated tree branch 910 attached to sensor 920; sensor 920 attached to tree trunk 540; motion sensor 930 attached to artificial tree branch 910; insulated and un-insulated conductive members 940 attached to artificial tree branch 910; control unit 500 attached to tree trunk 540; and charger 550/800 attached to tree trunk 540. Sensor 920 may detect changes in the angle of artificial tree branch 910 relative to tree trunk 540 or may detect changes in the weight of artificial tree branch 910 in effect to detect the presence or absence of a bird or small animal along artificial tree branch 910. Motion sensor 930 may detect physical motions along artificial tree branch 910 in effect to detect the presence or absence of a bird or small animal along artificial tree branch 910. As per the aforementioned, sensor 920 or motion sensor 930 may control the on/off connection between controller 500 and conductive members 940 via connective means 510. Once the presence of a bird or small animal is detected along artificial tree branch 910 then the connection between controller 500 and conductive members 940 via connective means 510 may be turned ON in order to activate the system thereby providing the pre-set voltage/current waveform to conductive members 940. System 900 does not have to include both sensor 920 and motion sensor 930. FIG. 9 shows both sensors solely for illustrative purposes. Connective means 511 connects charger 550/800 to control unit 500. When the bird, small animal or the like steps upon the paired-conductor un-insulated module portion the bird, small animal or the like is given an electrical shock causing the it to leave the area.

### Detailed Features of the Present Invention

The system comprises: a plurality of two-conductor or paired conductor modules or units with some modules being fully insulated and with other modules being both partially insulated and partially un-insulated; wherein birds, small animals or the like can complete an electrical circuit with parts of their body between the two-conductors of the un-insulated module portions thereby providing an electrical shock to the bird, small animal or the like.

For each two-conductor partially insulated and partially un-insulated module, the total length of the insulated portions relative to the total length of un-insulated portions being about 2 to 3.

For each two-conductor partially insulated and partially un-insulated module, the length of each insulated portion being about 2 inches and the length of each un-insulated portion being about 3.5 inches.

The distance or separation between the two-conductors is at least ½ inch.

The diameter of the conductors may be from about 12 gauge to about 18 gauge.

The conductors may be made of copper wire, aluminum wire, plastic metallic wire, galvanized steel wire or the like.

The conductors are secured within or along grooves cut into or located on spaced-apart base support members.

The distance or separation between the base support members is about 12 inches.

The conductors are secured within or along parallel grooves cut into or located on spaced-apart base support members.

The conductors are secured within or along grooves cut into or located on spaced-apart base support members; said base support members being made from polyethylene.

The conductors are secured within or along grooves cut into or located on spaced-apart base support members; said base support members have a rectangular cross-section.

The conductors are secured within or along grooves cut into or located on spaced-apart base support members; said base support members having a square cross-section.

The conductors are secured within or along grooves cut into or located on spaced-apart base support members; said base support members having a circular cross-section.

Certain conductors are first secured within or along first parallel grooves cut into or located on a base support member; and then such certain conductors are secured within or along second parallel grooves being perpendicular to said first parallel grooves cut into or located on said base support member.

The conductors are secured within or along grooves cut into or located on spaced-apart base support members; said base support members including means for being secured to a substrate.

The conductors are secured within or along grooves cut into or located on spaced-apart base support members; said base support members being about 12 inches apart.

The system comprises: a voltage/current source; a voltage/current controller-distributor being responsive to said source; a plurality of insulated two-conductor modules being responsive to said controller-distributor and being securely attached utilizing spaced-apart base support members; a plurality of partially insulated and partially un-insulated two-conductor modules being responsive to said insulated two-conductor modules and being securely attached utilizing spaced-apart base support members; wherein birds, small animals or the like can complete an electrical circuit with parts of their body between said un-insulated two-conductor module portions thereby providing an electrical shock to such bird, small animal or the like.

The controller-distributor provides a fixed voltage waveform output.

The controller-distributor provides a pulse voltage waveform output.

The controller-distributor provides a sinusoidal voltage waveform output.

The controller-distributor provides a triangular voltage waveform output.

The voltage/current source is a solar powered battery charger.

The system is capable of providing a potential difference output amplitude of about 4 volts.

The system is capable of providing a current of about 0.02 amps.

The system comprises: a voltage/current source; a voltage/current controller-distributor being responsive to said source; a distribution terminal being responsive to said controller-distributor and including a plurality of paired output terminals for accommodating a plurality of insulated two-conductor modules each being responsive to said controller-distributor; a plurality of partially insulated and partially un-insulated two-conductor modules each being responsive to said insulated two-conductor modules; wherein birds, small animals or the like can complete an electrical circuit with parts of their body between the two-conductors of the un-insulated module portions thereby providing an electrical shock to the bird, small animal or the like.

The wire connector terminal may provide about 20 separate wire outputs or about 10 paired-wire outputs.

The wire connector terminal may include a waterproof vinyl cover that will strap it to a tree trunk.

The waterproof vinyl cover may include two straps; the first strap for holding the terminal unit in place under the waterproof cover; and the second strap being adjustable for adhering the wire terminal unit to a tree trunk.

The waterproof vinyl cover may include Velcro means to waterproof the connections.

The system comprises: a voltage/current source being located on the trunk of a tree; a voltage/current controller-distributor being responsive to said source and being located on the trunk of such tree; an artificial tree branch being rotatingly attached to the trunk of such tree; a plurality of insulated two-conductor modules being responsive to said controller-distributor and being securely attached to said artificial tree branch utilizing spaced-apart base support members; a plurality of partially insulated and partially un-insulated two-conductor modules being responsive to said insulated two-conductor modules and being securely attached to said artificial tree branch utilizing spaced-apart base support members; wherein birds, small animals or the like may complete an electrical circuit with parts of their body between the two-conductors of the un-insulated module portions thereby providing an electrical shock to the bird, small animal or the like.

The artificial tree branch is rotatingly attached to the trunk of the tree; wherein an angular motion sensor senses the relative rotation of the artificial tree branch relative to the tree trunk thereby indirectly detecting the presence or absence of birds, small animals or the like for respectively turning the system ON or OFF. The angular motion sensor may indirectly detect the weight of the birds or small animals.

The system may further comprise a motion sensor directed along the artificial tree branch for detecting the presence or absence of birds, small animals or the like for respectively turning the system ON or OFF.

A method comprising the step of: providing a plurality of two-conductor modules or units with some modules being fully insulated and with other modules being partially un-insulated; wherein birds, small animals or the like complete an electrical circuit with parts of their body between the two-conductors of the un-insulated module portions.

The method of securing said plurality of paired conductors along grooves cut into or located on spaced-apart base support members.

The method securing said plurality of paired conductors along parallel grooves cut into or located on spaced-apart base support members.

The method including the step of securing paired conductors along first parallel grooves cut into or located on a base support member; and then securing such paired conductors along second parallel grooves being perpendicular to said first parallel grooves cut into or located on said base support member.

The method securing said plurality of paired conductors along grooves cut into or located on spaced-apart base support members; said base support members including means for being secured to a substrate.

A method comprising the steps of: providing a voltage/current source; providing a voltage/current controller-distributor being responsive to said source; providing a plurality of insulated two-conductor modules being responsive to said controller-distributor and being securely attached to a substrate such as a tree utilizing spaced-apart base support members; providing a plurality of partially insulated and partially un-insulated two-conductor modules being responsive to said insulated two-conductor modules and being securely attached to a substrate such as a tree utilizing spaced-apart base support members; wherein birds, small animals or the like may complete an electrical circuit with parts of their body between the two-conductors of the un-insulated module portions thereby providing an electrical shock to the bird, small animal or the like.

The method wherein said controller-distributor provides a fixed amplitude voltage waveform output.

The method wherein said controller-distributor provides a pulse voltage waveform output.

The method wherein said controller-distributor provides a sinusoidal voltage waveform output.

The method wherein said controller-distributor provides a triangular voltage waveform output.

The method wherein said voltage/current source is a solar-powered battery charger.

A method comprising the steps of: providing a voltage/current source; providing a voltage/current controller-distributor being responsive to said source; providing a distribution terminal being responsive to said controller-distributor and including a plurality of paired output terminals for accommodating a plurality of insulated two-conductor modules each being responsive to said controller-distributor; providing a plurality of partially insulated and partially un-insulated two-conductor modules each being responsive to said insulated two-conductor modules; wherein birds, small animals or the like may complete an electrical circuit with parts of their body between the two-conductors of the un-insulated module portions thereby providing an electrical shock to the bird, small animal or the like.

A method comprising the steps of: providing a voltage/current source being located on the trunk of a tree; providing a voltage/current controller-distributor being responsive to said source and being located on the trunk of such tree; providing an artificial tree branch being rotatingly attached to the trunk of said tree; providing a plurality of insulated two-conductor modules being responsive to said controller-distributor and being securely attached to said artificial tree branch utilizing spaced-apart base support members; providing a plurality of partially insulated and partially un-insulated two-conductor modules being responsive to said insulated two-conductor modules and being securely attached to said artificial tree branch utilizing spaced-apart base support members; wherein birds, small animals or the like may complete an electrical circuit with parts of their body between the two-conductors of the un-insulated module portions thereby providing an electrical shock to the bird, small animal or the like.

The method allowing said artificial tree branch to be rotatingly attached to the trunk of said tree; and utilizing an angular motion sensor for sensing the rotation of said artificial tree branch relative to such trunk for detecting the presence or absence of the birds, small animals or the like.

The method providing a motion sensor being directed along said artificial tree branch for detecting the presence or absence of the birds, small animals or the like.

While the present invention has been described in terms of specific illustrative embodiments, it will be apparent to those skilled in the art that many other embodiments and modifications are possible within the spirit and scope of the disclosed principle.

What is claimed is:

1. A system for deterring birds, small animals or the like, said system comprising: a plurality of two-conductor modules with some modules being fully insulated and with other modules being partially insulated and partially un-insulated; wherein such birds, small animals or the like may complete with their body an electrical circuit between the two-conductors at said un-insulated module portions thereby providing an electrical shock to such bird, small animal or the like.

2. In the system of claim 1: wherein for each partially insulated and partially un-insulated module the length of the insulated portion relative to the length of un-insulated portion is about 2 to 3.

3. In the system of claim 1: wherein for each partially insulated and partially un-insulated module the length of the insulated portion is about 2 inches and the length of un-insulated portion is about 3.5 inches.

4. In the system of claim 1: wherein the separation between the two-conductors is at least ½ inch.

5. In the system of claim 1: wherein the conductors may be about 12 gauge to about 18 gauge.

6. In the system of claim 1: wherein the conductors may be made of copper wire.

7. In the system of claim 1: wherein the conductors may be made of aluminum wire.

8. In the system of claim 1: wherein the conductors may be made of plastic metallic wire.

9. In the system of claim 1: wherein the conductors may be made of galvanized steel wire.

10. In the system of claim 1: wherein the conductors are secured along grooves located on spaced-apart base support members.

11. In the system of claim 1: wherein the conductors are secured along parallel grooves located on spaced-apart base support members.

12. In the system of claim 1: wherein the conductors are secured along grooves located on spaced-apart base support members; and wherein said base support members are made from polyethylene.

13. In the system of claim 1: wherein the conductors are secured along grooves located on spaced-apart base support members; and wherein said base support members have a rectangular cross-section.

14. In the system of claim 1: wherein the conductors are secured along grooves located on spaced-apart base support members; and wherein said base support members have a square cross-section.

15. In the system of claim 1: wherein the conductors are secured along grooves located on spaced-apart base support members; and wherein said base support members have a circular cross-section.

16. In the system of claim 1: wherein a first two-conductor pair is secured along first parallel grooves located on a base support member; and wherein a second two-conductor pair is secured along second parallel grooves being perpendicular to said first parallel grooves located on said base support member.

17. In the system of claim 1: wherein the conductors are secured along grooves located on spaced-apart base support members; and wherein said base support members include means for being secured to a substrate.

18. In the system of claim 1: wherein the conductors are secured along grooves being located on spaced-apart base support members; and wherein said base support members are separated by about 12 inches.

19. A system for deterring birds, small animals or the like from a tree having a trunk and at least one branch, said system comprising: a voltage/current source being secured to such trunk; a voltage/current controller-distributor being secured to such trunk and being responsive to said source; a plurality of two-conductor insulated modules being responsive to said controller-distributor and being securely attached to such trunk and/or to such branch utilizing spaced-apart base support members; a plurality of two-conductor partially insulated and partially un-insulated modules being responsive to said insulated two-conductor modules and being secured to such branch utilizing spaced-apart base support members; wherein such birds, small animals or the like may complete with their body an electrical circuit between the two-conductors of said un-insulated module portions thereby providing an electrical shock to the bird, small animal or the like.

20. In the system of claim 19: wherein said controller-distributor provides a fixed amplitude voltage waveform output.

21. In the system of claim 19: wherein said controller-distributor provides a pulse voltage waveform output.

22. In the system of claim 19: wherein said controller-distributor provides a sinusoidal voltage waveform output.

23. In the system of claim 19: wherein said controller-distributor provides a triangular voltage waveform output.

24. In the system of claim 19: wherein said voltage/current source is a solar-powered battery charger.

25. A system for deterring birds, small animals or the like from a tree having a trunk and at least one branch, said system comprising: a voltage/current source being secured to such trunk; a voltage/current controller-distributor being secured to such trunk and being responsive to said source; a distribution terminal being secured to such trunk, being responsive to said controller-distributor, and including a plurality of paired output terminals for accommodating a plurality of insulated two-conductor modules each being responsive to said controller-distributor; a plurality of two-conductor partially insulated and partially un-insulated modules being responsive to said insulated two-conductor modules and being secured to such branch utilizing spaced-apart base support members; wherein such birds, small animals or the like may complete with parts of their body an electrical circuit between the two-conductors of said un-insulated module portions thereby providing an electrical shock to the bird, small animal or the like.

26. A system for deterring birds, small animals or the like from a tree including a trunk, said system comprising: a voltage/current source being located on such trunk; a voltage/current controller-distributor being responsive to said source and being located on such trunk; an artificial tree branch being rotatingly attached to such trunk; a plurality of insulated two-conductor modules being responsive to said controller-distributor and being secured to said trunk and/or to said artificial tree branch utilizing spaced-apart base support members; a plurality of two-conductor partially insulated and partially un-insulated modules being responsive to said insulated two-conductor modules and being secured attached to said artificial tree branch utilizing spaced-apart base support members; wherein such birds, small animals or the like may complete with parts of their body an electrical circuit between the two-conductors of said un-insulated modules thereby providing an electrical shock to the bird, small animal or the like.

27. In the system of claim 26: wherein said artificial tree branch is rotatingly attached to such trunk; and wherein an angular motion sensor detects the rotation of said artificial tree branch relative so such trunk for determining the presence or absence of such birds, small animals or the like.

28. In the system of claim 26: wherein said system further comprises a motion sensor being directed along said artificial tree branch for detecting the presence or absence of such birds, small animals or the like.

29. A method for deterring birds, small animals or the like, said method comprising the step of: providing a plurality of two-conductor modules with some modules being fully insulated and with other modules being partially un-insulated; wherein such birds, small animals or the like complete an electrical circuit with parts of their body between the two-conductors of the un-insulated module portions thereby providing an electrical shock to the bird, small animal or the like.

30. In the method of claim 29: securing said conductors along grooves located on spaced-apart base support members.

31. In the method of claim 29: securing said conductors along parallel grooves located on spaced-apart base support members.

32. In the method of claim 29: securing a first two-conductor pair along first parallel grooves located on a base support member; and securing a second two-conductor pair along second parallel grooves being perpendicular to said first parallel grooves located on said base support member.

33. In the method of claim 29: securing the conductors along grooves located on spaced-apart base support members; wherein said base support members include means for being secured to a substrate.

34. A method for deterring birds, small animals or the like from a tree including a trunk and at least one branch, said method comprising the steps of: providing a voltage/current source; providing a voltage/current controller-distributor being responsive to said source; providing a plurality of insulated two-conductor modules being responsive to said controller-distributor and being securely attached to said trunk and/or to said branch utilizing spaced-apart base support members; providing a plurality of partially insulated and partially un-insulated two-conductor modules being responsive to said insulated two-conductor modules and being securely attached to said branch utilizing spaced-apart base support members; wherein such birds, small animals or the like complete an electrical circuit with parts of their body between the two-conductors of the un-insulated module portions thereby providing an electrical shock to the bird, small animal or the like.

35. In the method of claim 34: said controller-distributor providing a fixed amplitude voltage waveform output.

36. In the method of claim 34: said controller-distributor providing a pulse voltage waveform output.

37. In the method of claim 34: said controller-distributor providing a sinusoidal voltage waveform output.

38. In the method of claim 34: said controller-distributor providing a triangular voltage waveform output.

39. In the method of claim 34: said voltage/current source being a solar-powered battery charger.

40. A method for deterring birds, small animals or the like from a tree including a trunk and at least one branch, said method comprising the steps of: providing a voltage/current source being secured to such trunk; providing a voltage/current controller-distributor being responsive to said source and being secured to such trunk; providing a distribution terminal being secured to such trunk, being responsive to said controller-distributor, and including a plurality of paired output terminals for accommodating a plurality of insulated two-conductor modules each being responsive to said controller-distributor; and providing a plurality of partially insulated and partially un-insulated two-conductor modules each being responsive to said insulated two-conductor modules and being secured to such branch; wherein such birds, small animals or the like complete an electrical circuit with parts of their body between the two-conductors of the un-insulated module portions thereby providing an electrical shock to the bird, small animal or the like.

41. A method for deterring birds, small animals or the like from a tree including a truck, said method comprising the steps of: providing a voltage/current source being located on such trunk; providing a voltage/current controller-distributor being responsive to said source and being located on such trunk; providing an artificial tree branch being rotatingly attached to such trunk; providing a plurality of insulated two-conductor modules being responsive to said controller-distributor and being attached to such trunk and/or to said artificial tree branch utilizing spaced-apart base support members; and providing a plurality of partially insulated and partially un-insulated two-conductor modules, being responsive to said insulated two-conductor modules and being attached to said artificial tree branch utilizing spaced-apart base support members; wherein such birds, small animals or the like complete an electrical circuit with parts of their body between the two-conductors of the un-insulated module portions thereby providing an electrical shock to the bird, small animal or the like.

42. In the method of claim 41: utilizing an angular motion sensor for sensing the relative rotation of said artificial tree branch relative to such trunk for detecting the presence or absence of such birds, small animals or the like.

43. In the method of claim 41: providing a motion sensor being directed along said artificial tree branch for detecting the presence or absence of such birds, small animals or the like.
